(19) United States
(12) Patent Application Publication
(10) Pub. No.: US 2018/0260081 A1
(43) Pub. Date: Sep. 13, 2018

(54) TASK SWITCHING OR TASK LAUNCHING BASED ON A RANKED LIST OF TASKS

(71) Applicant: GOOGLE INC., Mountain View, CA (US)

(72) Inventors: Philippe J. Beaudoin, Mount Royal (CA); Tien-Chieh Huang, Montreal (CA); Ruby Lee, San Francisco, CA (US); Pierre-Antoine Manzagol, Montreal (CA); Roger Delano Paul McFarlane, Montreal (CA); Shibl Mourad, Montreal (CA); Mathieu Perreault, Montreal (CA)

(21) Appl. No.: 14/446,760

(22) Filed: Jul. 30, 2014

(51) Int. Cl. G06F 3/0482; G06F 3/0481; G06F 9/48

(52) U.S. Cl. CPC G06F 3/0482; G06F 9/4806; G06F 3/04817

(57) ABSTRACT

A technique includes determining a ranked list of tasks that are ranked based on a likelihood of being selected by a user, the ranked list of tasks including a site identifier that identifies a site and a mode of navigation for the site as either a launch mode to launch a new page from the site or a switch mode to switch to a stored context of the site, displaying a task switcher/launcher interface that includes a selectable icon for a plurality of tasks from the ranked list of tasks, receiving, by a client application, a signal selecting one of the displayed tasks, determining a site and a mode of navigation for the selected task, and performing, by the client application, site navigation for the selected task based upon the mode of navigation for the selected task. A mode of navigation may include launch mode or switch mode.

### TECHNICAL FIELD

This description relates task switching or task launching based on a ranked list of tasks.

### BACKGROUND

Graphical User Interfaces (GUIs) sometimes include a tabbed document interface, where a tab is provided for each document or panel that is contained within a single window. Each of the tabs, for example, may identify a document and allow a user to select the document for display and/or editing. For example, some client applications, such as web browsers, provide vertical tabs that allow multiple documents or web pages to be manually managed (e.g., manually added, selected or deleted) by a user within a single window. A user may open more documents or web pages, and more tabs may accumulate at the top of a web browser. A user may manually manage the tabbed documents or tabs within the window by adding a new tabbed document or page, and deleting other tabbed documents.

### SUMMARY

According to an example implementation, a method is provided. The method may include determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site, displaying a task switcher/launcher interface that includes a selectable icon for a plurality of tasks from the ranked list of tasks, receiving, by a client application, a signal selecting one of the displayed tasks, determining a site and a mode of navigation for the selected task; and performing, by the client application, site navigation for the selected task based upon the mode of navigation for the selected task.

In an example implementation, performing site navigation for the selected task may include launching a new page of the site for the selected task if the mode of navigation for the selected the task is launch mode, and switching to a stored context of the site for the task if the mode of navigation for the selected task is switch mode.

In an example implementation, the determining a ranked list may include receiving the ranked list from a task recommendation engine running on a server.

In an example implementation, the receiving, by a client application, a signal selecting one of the displayed tasks may include receiving, by the client application, one signal, wherein a decision of whether to launch a new page of the site or switch to a stored context for the site, in response to receiving the one signal, is determined by the client application based on the mode of navigation for the selected task.

In an example implementation, the displayed icon for one or more of the tasks includes a displayed sub-icon that identifies the mode of navigation for the task.

In an example implementation, the method may further include receiving a task switcher/launcher request signal, determining whether the task switcher/launcher request signal is a first gesture or a second gesture, wherein the displaying a task switcher/launcher interface includes displaying, if the task switcher/launcher request signal is the first gesture, a task switcher/launcher interface that includes a selectable icon for a plurality of tasks from the ranked list of tasks that each have launch mode as a mode of navigation, and displaying, if the task switcher/launcher request signal is the second gesture, a task switcher/launcher interface that includes a selectable icon for a plurality of tasks from the ranked list of tasks that each have switch mode as a mode of navigation.

In an example implementation, the determining a ranked list of tasks is performed based upon one or more of the following: user activity metadata for a plurality of sites, whether a context for a site is stored or available, and general use metadata of multiple users for a plurality of sites.

In an example implementation, the user activity metadata may include one or more of the following: frequency of visits to a site, time and duration of visits to a site, amount of user interaction at a site, relative frequency of launching vs. switching to a site, and feedback from a user indicating that a navigated site has been rejected by the user.

In an example implementation, the selected task may include a first selected task, and the method may further include receiving feedback from the user rejecting the first selected task, and displaying a second selected task having a site that is a same site as the first selected task, and a mode of navigation that is different than the first selected task.

In an example implementation, performing site navigation for the selected task may include performing, by the client application, site navigation for the selected task for a first mode of navigation. The method may further include determining that the client application remained at the navigated site for the first mode of navigation for an amount of time that is less than a threshold, and performing site navigation to the site of the selected task for a second mode of navigation that is different than the first mode of navigation.

In an example implementation, performing site navigation for the selected task may include launching a new page of the site for the selected task. The method may further include determining that the client application remained at the launched page for an amount of time that is less than a threshold, and switching to a stored context of the site for the task.

In an example implementation, performing site navigation for the selected task includes switching to a stored context of the site for the selected task. The method may further include determining that the client application remained at the stored context of the site for an amount of time that is less than a threshold, and launching a new page of the site for the selected task.

In an example implementation, the ranked task list may include a first task with a first site identifier that identifies a first site and a mode of navigation of launch mode, and one or more second tasks with the first site identifier that identifies the first site and a mode of navigation of switch mode to switch to a stored context for the site.

In an example implementation, the method may further include storing one or more contexts for one or more sites based on user interaction with the site, and deleting, as stored contexts reach a threshold number or reach a threshold amount of memory, one or more stored contexts for lowest ranked tasks within the ranked list of tasks.

According to another example implementation an apparatus may include means for determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site, means for displaying a task switcher/launcher interface that includes a selectable icon for a plurality of tasks from the ranked list of tasks, means for receiving, by a client application, a signal selecting one of the displayed tasks, means for determining a site and a mode of navigation for the selected task, and means for performing, by the client application, site navigation for the selected task based upon the mode of navigation for the selected task.

According to another example implementation, a computer program product may include a non-transitory computer-readable storage medium and storing executable code that, when executed by at least one data processing apparatus, is configured to cause the at least one data processing apparatus to perform a method including: determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site, displaying a task switcher/launcher interface that includes a selectable icon for a plurality of tasks from the ranked list of tasks, receiving, by a client application, a signal selecting one of the displayed tasks, determining a site and a mode of navigation for the selected task, and performing, by the client application, site navigation for the selected task based upon the mode of navigation for the selected task.

In an example implementation, the performing site navigation for the selected task may include: launching a new page of the site for the selected task if the mode of navigation for the selected the task is launch mode, and switching to a stored context of the site for the task if the mode of navigation for the selected task is switch mode.

According to another example implementation, an apparatus may include at least one processor and at least one memory including computer instructions, when executed by the at least one processor, cause the apparatus to: determine a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site, display a task switcher/launcher interface that includes a selectable icon for a plurality of tasks from the ranked list of tasks, receive, by an application running the apparatus, a signal selecting one of the displayed tasks, determine a site and a mode of navigation for the selected task, and perform, by the client application, site navigation for the selected task based upon the mode of navigation for the selected task.

In an example implementation, the instructions that cause the apparatus to perform, by the client application, site navigation for the selected task may include instructions that cause the apparatus to: launch a new page of the site for the selected task if the mode of navigation for the selected the task is launch mode, and switch to a stored context of the site for the task if the mode of navigation for the selected task is switch mode.

According to another example implementation, a method may include receiving one or more signals, determining, for a user based on the one or more signals, a ranked list of tasks that are ranked based on a likelihood of being selected by the user, the ranked list of tasks including, for one or more tasks, a site identifier that identifies a site and a mode of navigation for the site as either a launch mode to launch a new page from the site or a switch mode to switch to a stored context of the site, receiving, from a client application associated with the user, feedback associated with a selection of one or more of the tasks for display, and feedback associated with a rejection of one or more tasks that were displayed, updating the ranked list of tasks for the user based on the feedback from the client application, and providing the updated ranked list of tasks to the client application.

In an example implementation, the receiving feedback may include receiving a first feedback signal from the client application associated with the user that the user selected a first task of the ranked list of tasks for display, and receiving a second feedback signal from the client application indicating that the user rejected the display of the first task.

In an example implementation, the receiving a second feedback signal may include receiving a second feedback signal from the client application indicating that the user or client application remained on a page for the site displayed for the first task for an amount of time that is less than a threshold.

In an example implementation, the receiving a first feedback signal may include receiving a first feedback signal from a client application associated with the user selected and displayed a first task, including a first site associated with a first mode of navigation, of the ranked list of tasks. The receiving a second feedback signal may include receiving a second feedback signal from the client application indicating that, after display for the first site associated with the first mode of navigation, the user rejected the display of the first site associated with the first mode of navigation, and instead selected for display a second task including the first site and a second mode of navigation that is different than the first mode of navigation.

In an example implementation, the receiving feedback may include receiving a signal from the client application indicating that, after a site for the first task was displayed, the client application remained on the site for an amount of time that is less than a threshold.

In an example implementation, the one or more signals may include one or more of user activity metadata for a plurality of sites, whether a context for a site is stored or available, and general use metadata of multiple users for a plurality of sites. The user activity metadata may include one or more of the following: frequency of visits to a site, time and duration of visits to a site, amount of user interaction at a site, relative frequency of launching vs. switching to a site, feedback from a user indicating that a navigated site (either launched or switched) for a site was rejected by the user or client application.

According to another example implementation, an apparatus may include means for receiving one or more signals, means for determining, for a user based on the one or more signals, a ranked list of tasks that are ranked based on a likelihood of being selected by the user, the ranked list of tasks including, for one or more tasks, a site identifier that identifies a site and a mode of navigation for the site as either a launch mode to launch a new page from the site or a switch mode to switch to a stored context of the site, means for receiving, from a client application associated with the user, feedback associated with a selection of one or more of the tasks for display, and feedback associated with a rejection of one or more tasks that were displayed, means for updating the ranked list of tasks for the user based on the feedback from the client application, and means for providing the updated ranked list of tasks to the client application.

According to another example implementation, an apparatus may include at least one processor and at least one memory including computer instructions, when executed by the at least one processor, cause the apparatus to: receive one or more signals, determine, for a user based on the one or more signals, a ranked list of tasks that are ranked based on a likelihood of being selected by the user, the ranked list of tasks including, for one or more tasks, a site identifier that identifies a site and a mode of navigation for the site as either a launch mode to launch a new page from the site or a switch mode to switch to a stored context of the site, receive, from a client application associated with the user, feedback associated with a selection of one or more of the tasks for display, and feedback associated with a rejection of one or more tasks that were displayed, update the ranked list of tasks for the user based on the feedback from the client application, and provide the updated ranked list of tasks to the client application.

According to another example implementation, a computer program product may include a non-transitory computer-readable storage medium and storing executable code that, when executed by at least one data processing apparatus, is configured to cause the at least one data processing apparatus to perform a method including receiving one or more signals, determining, for a user based on the one or more signals, a ranked list of tasks that are ranked based on a likelihood of being selected by the user, the ranked list of tasks including, for one or more tasks, a site identifier that identifies a site and a mode of navigation for the site as either a launch mode to launch a new page from the site or a switch mode to switch to a stored context of the site, receiving, from a client application associated with the user, feedback associated with a selection of one or more of the tasks for display, and feedback associated with a rejection of one or more tasks that were displayed, updating the ranked list of tasks for the user based on the feedback from the client application, and providing the updated ranked list of tasks to the client application.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a system 100 according to an example implementation.

FIG. 2 is a diagram illustrating a tabbed browser 200 according to an example implementation.

FIG. 3 is a diagram of a tabless browser 300 according to an example implementation.

FIG. 4 is a diagram illustrating a browser 400 according to another example implementation.

FIG. 5 is a diagram illustrating a browser 500 according to another example implementation.

FIG. 6 is a diagram illustrating additional tasks that may be displayed for browser 500 when a more button is pressed according to an example implementation.

FIG. 7 is a flow chart illustrating operation of a client application according to an example implementation.

FIG. 8 is a flow chart illustrating operation of a task recommendation engine according to an example implementation.

FIG. 9 shows an example of a generic computer device 900 and a generic mobile computer device 950, which may be used with the techniques described here.

### DETAILED DESCRIPTION

This document describes systems and techniques related to task management, and in particular to task switching and task launching based on a ranked list of tasks.

According to an example implementation, a task recommendation engine may receive a variety of different signals, and may generate, and periodically update, a ranked list of tasks for one or more users. The task recommendation engine may generate and update the ranked list of tasks based on, for example, user activity metadata with respect to various sites (e.g., web pages, web sites, web applications or other content), whether a context for a site is stored, general use metadata for various sites, and other signals. A client application (such as a web browser) may receive the ranked list of tasks for a user and may display a task switcher/launcher interface including a ranked task bar that includes an icon for each of a plurality of ranked tasks from the ranked list of tasks.

In an example implementation, a user pressing or selecting an input, such as a task switcher/launcher request button may, for example, cause the client application to retrieve a ranked list of tasks for the user and then to display a portion of the ranked list of tasks within the ranked task bar, e.g., as proposed or suggested sites or tasks for the user. A user may select one of the displayed tasks. In response to a signal selecting a displayed task, the client application may determine a site and a mode of navigation for the selected task, and may perform site navigation for the selected task based upon the site and mode of navigation for the selected task. For example, performing site navigation may include launching a new page from the site based on the site identifier (e.g., URL) for the selected task if the mode of navigation is launch mode. Site navigation may also include switching to a stored context of the site associated with the selected task if the mode of navigation is switch mode.

Also, according to an example implementation, the task recommendation engine may learn from mistakes or errors, and may correct, or otherwise improve, launch/switch decisions for tasks or task ranking decisions. For example, task recommendation engine may update or improve task ranking decisions by updating a ranking of one or more tasks within the ranked list of tasks for the user based on user feedback. Also, the client application (e.g., browser) may perform additional actions (e.g., such as performing navigation for other tasks, or re-displaying the ranked task bar with tasks having their ranking adjusted based on this user feedback) in response to receiving information that the requested or displayed task/site was not what the user wanted to select/display.

According to an example implementation, a technique may include determining a ranked list of tasks that are ranked based on a likelihood of being selected by a user. The ranked list of tasks may include a site identifier that identifies a site and a mode of navigation for the site as either a launch mode to launch a new page from the site or a switch mode to switch to a stored context of the site. The technique may also include displaying a task switcher/launcher interface that includes a selectable icon for a plurality of tasks from the ranked list of tasks, receiving, by a client application, a signal selecting one of the displayed tasks, determining a site and a mode of navigation for the selected task, and performing, by the client application, site navigation for the selected task based upon the mode of navigation for the selected task.

According to an example implementation, performing site navigation for the selected task may include either launching a new page of the site for the selected task if the mode of navigation for the selected the task is launch mode, or switching to a stored context of the site for the task if the mode of navigation for the selected task is switch mode. Feedback may be received from the user indicating that the user has rejected a selected task, or is requesting display of a different task.

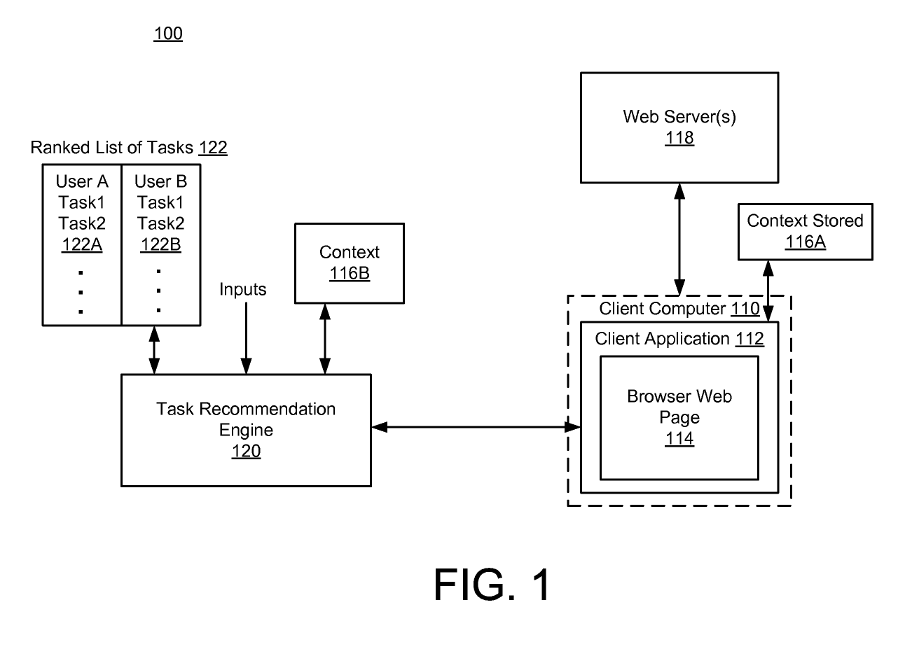

FIG. 1 is a block diagram illustrating a system 100 according to an example implementation. System 100 may include a client computer 110, a client application 112 running on client computer 110. Client application 112 may retrieve or download content from one or more servers (e.g., web servers) 118. A task recommendation engine 120 is coupled to client computer 110. Task recommendation engine 120 may generate a ranked list of tasks 112. Contexts for various content (e.g., web pages, web documents, applications) may be stored in a stored context 116, which may be stored locally on a computer as stored contexts 116A, or may be stored, for example, on a server at stored contexts 116B. Further details of system 100 will now be described with reference to FIG. 1.

Client computer 112 may be, for example, a personal computer (PC), laptop, netbook, tablet, smart phone, cell phone, or any other computing device. Although not shown in FIG. 1, client computer 110 may include memory to store instructions and data, a processor (e.g., a silicon-based hardware processor) to execute instructions and software programs, input/output devices to allow a user to input signals to client computer 110 and to output or display information to a user, and a network adapter or network interface to allow client computer 110 to communicate with other computers via one or more networks. Example input/output devices may include a mouse, keyboard, trackpad, a touchpad, or other pointing device or other input devices, and one or more output devices, such as a display.

One or more applications may run on client computer 110, such as a client application 112, which may be, for example, a web browser. In another example implementation, client application 112 may include one or more additional applications, such as, for example, a messaging application, and one or more applications to access locally stored content (stored locally on computer 110) or network-stored content, such as a word processing application, a spreadsheet application, a picture or video review/editing application, an accounting or bookkeeping application, a tax program, etc. Therefore, application 112 may include a wide variety of applications that may be running on computer 110, not limited to a web browser, for example. Application 112 (which may include one or more applications) may access both local content and online content (e.g., content stored on one or more servers, or stored on the cloud). When client application 112 is running or executing on client computer 110, a browser web page 114 may be output or displayed on a display or output device. Client application 112 (e.g., web browser) may retrieve information, such as web pages from one or more websites or other content, e.g., which may reside on one or more web servers 118. For example, client application 112 may retrieve and display or output various content such as web pages, streaming audio or music from one or more music websites, videos from various video websites, documents and other data from online document management/storage sites, pictures from a website that stores digital photos or pictures, and the like. Also, application 112 may retrieve and output locally stored content or applications, such as, for example, text documents, spreadsheets, pictures/images, and other content or applications. For example, the content that may be retrieved or downloaded from websites may include weather information from a weather website, news articles from one or more news websites, information from one or more social media websites, etc. These are merely a few examples, and many other types of information or content may be retrieved and output or displayed.

Task recommendation engine 120 may, for example, reside on a server or as part of a cloud service, or may be provided as a program running on client computer 110. Task recommendation engine 120 may be coupled with, or in communication with, client application 112, for example. A user may manually control tabs (or tabbed pages), including manually launching a new tabbed web page, switching between different tabbed pages/documents by selecting different tabs, and deleting or closing some open tabbed pages. According to an example implementation, instead of manually controlling tabbed documents, or in addition to manually controlling tabbed documents, the ranked list of tasks 122 provided by task recommendation engine 120 may allow client application 112 to provide automated content management in which, for example, the client application 112 may electronically or automatically control the opening and closing of pages or other content, determine which previously visited pages or content should be stored (or deleted) as a context to be later retrieved for display, and to determine whether a new page should be launched (download a new page from a site or retrieve and display a cached version of the page with a fresh or empty context) or switched to a saved context for the page.

According to an example implementation, task recommendation engine 120 may determine or generate a ranked list of tasks 122 for one or more users, e.g., including a ranked list of tasks 122A for user A, and a ranked list of tasks 122B for user B. The ranked list of tasks 122 may be used by client application 112 to automatically manage opening and closing of new content (e.g., web pages or other content) and/or manage the displaying or presenting stored contexts of content or web pages, for example. In one example implementation, manual management of tabbed documents may be replaced with an electronic or automatic content management provided by client application 112 based on a ranked list of tasks 122 provided by task recommendation engine 120. In another example implementation, the use of tabbed documents or tabs may be supplemented through an automatic or electronic management of content or web pages provided by client application 112 based on a ranked list of tasks 122.

According to an example implementation, task recommendation engine 120 may determine a ranked list of tasks 122 for one or more users, where the tasks may be, for example, ranked based on a likelihood of being selected by a user. For example, the ranked list of tasks 122 may include, for each ranked task, a site identifier that identifies a site, and a mode of navigation for the site as either a launch mode to launch a new page from the site or a switch mode to switch to a stored context of the site. As an example, the site identifier may be a Uniform Resource Locator (URL) for a web page or document, or other address that identifies content, a page or an application. For online documents, the site identifier may identify the address or location where the document (e.g., text document, spreadsheet, digital image, video) is stored online or on a server. For example, for locally stored content (e.g., locally stored text document or digital image/picture), the site identifier may be an address or location identifying the stored location of the content.

The mode of navigation may, for example, identify a launch mode (task launching a site) or a switch mode (task switching a site). Task launching a site means, for example, that the client application 112 or web browser retrieves a new or fresh web page from the website or address, e.g., fully downloading the currently-existing page or content from the website. On the other hand, task switching a site means, for example, that the client application 112 or web browser retrieves historical content or a historical context for the page from memory, and then presents the page or content based on the stored content or context. In one implementation, the historical content or context of a page can be defined by the content/context of the page at the time the user last interacted with the page, and then by task switching to the site or web page, the user may receive the content of the web page in exactly the same state that the user left it in when exiting from the web page. Contexts for one or more sites or pages may be stored (e.g., by client application 112 or task recommendation engine 120 or other application) in stored contexts 116, such as in a stored contexts 116A stored locally on client computer 110, and/or a stored contexts 116B which may be provided on server, cloud service, etc. Stored contexts 116 may be accessible by client computer 110 and task recommendation engine 120.

By way of example, a context for a site or web page may include a stored copy of the web page (or document) and the remaining context for the page, such as, one or more of a URL or address for the site or web page, the page number of a text (or word processing application) document that was being displayed, a portion of the webpage that is displayed according to the scroll status of the page, a location of a cursor on the page, data entered into a document or fields of a document filled in, a time location of a song (audio) or time location of a video, or other information describing a state of the page as seen by the user. Therefore, task switching may include the client application 112 retrieving the stored web page (or document) from memory and then applying the remaining context to the retrieved page to restore the state of the document, e.g., to advance to the correct page number, scroll to the correct location on the page, place the cursor in the correct location on the page, enter any data that was entered by the user into the document or page, etc., based on the stored context for the page. Thus, by task switching to a site or web page, the client application 112 or web browser may restore the page or document to the same state as last seen by the user based on this stored context. Task switching is similar to (or analogous to) switching from a first tabbed document to a second tabbed document in a tabbed browser, whereas task launching is similar to (or analogous to) loading a new page or website into a new tab or a current tab in a tabbed browser.

As noted, task recommendation engine 120 may generate a ranked task list for each of a plurality of users. The tasks may be ranked based on a likelihood of being selected by a user, e.g., where a higher ranked task has been determined by the task recommendation engine 120 to have a greater likelihood of being selected by the user. Each task in the ranked list of tasks 122 may include a site identifier (such as a URL or other address), which may identify a resource, web content such as a web page, and a mode of navigation (either launch mode or switch mode). A same site can correspond to multiple tasks and can therefore be included multiple times (e.g., same site, but provided for different tasks) within the ranked list of tasks, and such tasks (corresponding to the same site) may be displayed or proposed by the by the client application 112 to a user via a task switcher/launcher interface, described in greater detail below.

For example, some example tasks within a ranked list of tasks may include the following:
Task 1: A site (e.g., a website) of a user's online documents, with a context to document 1, switch mode (to switch to the context of document 1);
Task 2: A site of the user's online documents, with a context to document 2, switch mode (to switch to the context of document 2); and
Task 3: A site of the user's online documents, launch mode (to launch a new page from a docs/documents website).

Below is another example of a ranked list of tasks (the site identifiers may be a URL or other address to a website or other online content, or an address to locally stored content, as examples):

Task 4:

Site identifier: news-website.com

Mode of navigation: Launch

Task 5:
Site identifier: streamingmusicsite.com
Mode of Navigation: Launch

Task 6:
Site identifier: espn.com
Mode of navigation: Launch

Task 7:
Site identifier: espn.com/article-re-2014-superbowl
Mode of Navigation: Switch

Task 8:
Site identifier: summercampforkids.com/registration-form
Mode of Navigation: Switch

In the example of ranked list of tasks described above, task 4 is a launch to the site news-website.com, where a new/fresh page is downloaded from this site and displayed by client application 112. Task 5 is a launch of streaming music from the music site streamingmusicsite.com. Task 6 is a launch of a new page from espn.com. Task 7 is a context switch to a specific article on ESPN website, e.g., where the specific page number that was open, scrolling and cursor location, etc., have been stored in the stored context for this task, and may be used to restore the state for this site that was last visited or used by the user, for example. Task 8 is a context switch to a registration form for a summercampforkids.com website. Context information for this task and site may be stored in the stored context 116 and may be used to restore the state of this task to the same state as when the user last visited this website, e.g., including any text that the user may have filled in this registration form before the page/form was closed. A context for each of tasks 7 and 8 may be stored in stored contexts 116, and then retrieved by the client application 112 and used to context switch to this site/task based on the stored context. In another example implementation, a site (or site address) may refer to a locally stored document or content.

Task recommendation engine 120 may, based on one or more signals, determine a ranked list of tasks that are ranked based on a likelihood of being selected by a user, the ranked list of tasks including, for one or more tasks, a site identifier that identifies a site and a mode of navigation for the site. For example, the task recommendation engine 120 may determine a ranked list of tasks based upon signals relating to one or more of the following: user activity metadata for a plurality of sites (which may include a user's task switching/launching history), whether a context for a site is stored or available, general use metadata of multiple users for a plurality of sites, and intrinsic metadata which may include metadata about a site itself, e.g., number of inlinks, etc. that are used to determine a PageRank for a page, and other signals. Other signals that may be used by task recommendation engine 120 may include, for example, detection of a pattern in a URL of a site, such as extracting a task's content from the URL of a site (such as a code describing the document being accessed or reviewed, which may be present in a URL's parameters), activity on side channels related to the site (such as a Rich Site Summary (RSS) feed), activity on external channels that may be linked to page or site (e.g., twitter or other social media posts linking, referencing or mentioning the page, task or site, an email referencing the task, page or site), a user's physical location, e.g., if the user is browsing with a mobile device, external events known to be correlated with the task usage (e.g., the user received a phone call or message indicating that a weather warning is in effect), time spent by the user on a given site, etc.

General use metadata may include data relating to the general usage, behavior or activity of many users in general, such as a time of day or day of week of multiple user's activity on a site. For example, general use metadata may indicate that 90% of all users selecting a specific news website will download a new or fresh web page from the site's front page each time the user views such site, whereas 10% of users may download and display a stored context of such site.

Also, presence of a stored context may allow use of that stored context for a task within a ranked list of tasks. For example, if a context is available for a site or page, then then task recommendation engine 120 may rank a task for this site and context.

The user activity metadata may include, for example, any data that describes or relates to the user's behavior or activity with respect to content, sites or services, such as web pages, websites, documents, applications, and cloud services. The user activity metadata may relate to or describe specific behavior of the user, including the user's task switching/launching history such as selecting specific websites or content at specific times, searches that were run, information or data input into a web page or document, time spent on specific site (what time, and how long spent on a site or page), time of day or day of week of user's activity on a site, the user's history of launching or switching to specific sites, such as every launch/switch operation the user performed in the past including any signal collected at that time (such as the time of day when the operation was performed, location, etc.), and any instances in which the user rejected or corrected the launch/switch decision, etc.

By way of example, user activity metadata (which may include a user's task switching/launching history) may include one or more of the following: frequency of visits to a site, time and duration of visits to a site, amount of user interaction at a site, relative frequency of launching vs. switching to a site, feedback from a user indicating that a navigated site has been rejected by the user after it was selected by the user and displayed to the user. For example, site rejection may include, for example, the user spending less than a threshold amount of time (e.g., less than 6 seconds) at the selected site or page before navigating to another page or site.

According to one example, a user may typically (e.g., 90% of every day or 90% of working days) open a news website to a new or fresh page in the morning (e.g., before 10 am), while that user may typically view and interact with an already open (context switch mode) page on that same news website after 10 am. According to an illustrative example, based on this information and user activity metadata for this particular website (e.g., a greater likelihood the user will launch a new page in the morning before 10 am, and switch to an existing context after 10 am), the task recommendation engine 120, based on user activity metadata and various time information, may increase the rank of a launch mode task for this news website, and decrease the rank of a switch mode of this news website from 12 midnight until 10 am, within the ranked list of tasks 122 for the user. The ranked list of tasks may be frequently updated, e.g., as time changes, or based on additional signals. Therefore, in this example, the task recommendation engine 120 may then lower the rank (within the ranked list of tasks 122) of a launch mode task for this news website, and may increase the rank of one or more context mode tasks for this website between 10 am and 12 midnight, for example. In this manner, within the ranked list of tasks 122, the tasks that are more likely to be selected or wanted by the user will be ranked higher than the tasks that are less likely to be selected or wanted by the user. This is merely one example, and many other examples and techniques may be used to periodically or frequency adjust or update the ranked list of tasks for a user.

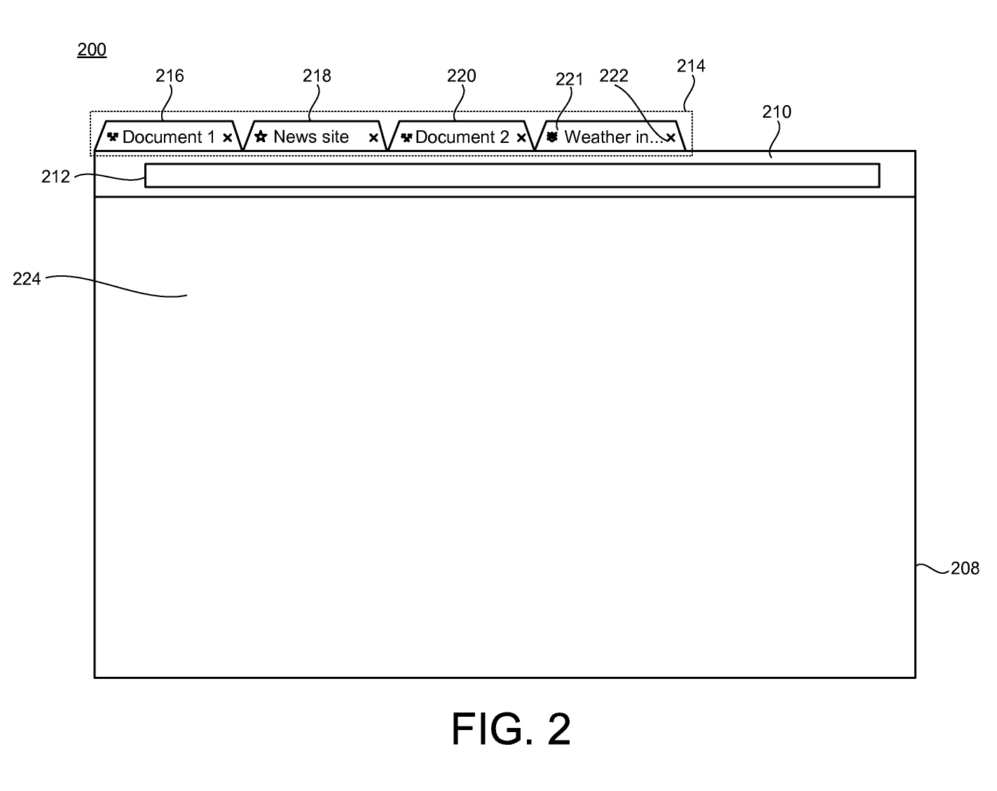

FIG. 2 is a diagram illustrating a tabbed browser 200 according to an example implementation. According to an example implementation, one or more of the various techniques described herein may be used with a tabbed browser, such as, for example, shown in FIG. 2. Tabbed browser 200 may include a graphical user interface (GUI) that includes a window 208, which may a two-dimensional object arranged on a plane of the GUI known as the desktop. Window 208 may include various GUI objects, such as, for example, a toolbar 210, a tab strip 214 that may include one or more tabs, and a content area 224 to display content for a selected tab or document. Toolbar 210 may include a number of tabs, such as tabs 216, 218, 220 and 221. Each tab may be associated with a document or page. In this example, tab 218 has been selected and is an active tab, which causes the content or page associated with tab 218 to be display, and documents or pages associated with other (inactive) tabs to be hidden, for example. The non-selected (or inactive) tabs may also be referred to as background tabs, such as tabs 216, 218 and 221. A page title is provided for each tab, such as the titles: Document 1 (tab 216), News site (tab 218), Document 2 (tab 220) and Weather In . . . (tab 221). An omnibox (or search box) 210 is provided and may allow a user to enter search terms or a URL, for example.

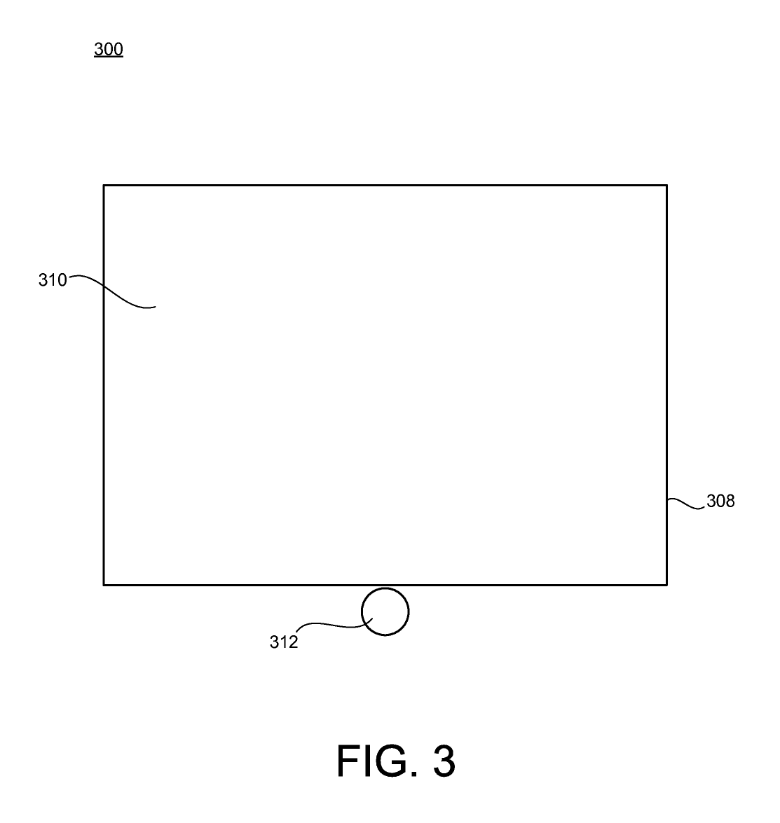

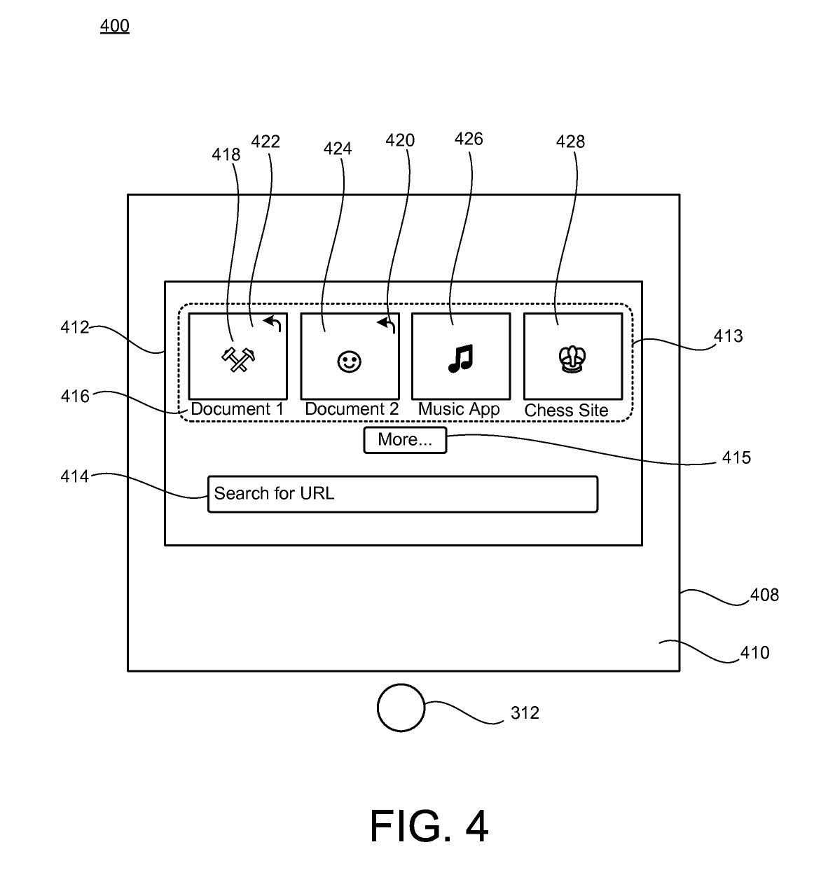

FIG. 3 is a diagram of a tabless browser 300 according to an example implementation. Browser 300 may include a window 308, which includes a content area 310. In addition, a task switcher/launcher request button 312 may also be provided, and may alternatively referred to as a browser action button. Task switcher/launcher request button 312 (or other GUI object or gesture) may, for example, be selected by a user to display a task switcher/launcher interface 412, shown and described with respect to FIG. 4. The example browser 300 may be considered tabless because documents or pages that are managed or displayed in the window 308 do not necessarily have tabs for manual selection and management of tabbed documents. The various aspects described herein may be applied to either a tabbed browser, for example as shown in FIG. 2, or a tabless browser, for example as shown in FIG. 3.

The task switcher/launcher request button 312 may, for example, be located anywhere inside or outside the content area 310, may be a system-level button, a soft button, a physical button, one or more gestures on a touch screen (e.g., swipe left, double tap, . . . ), a special keystroke combination (e.g., ctrl-L), or other input signal.

FIG. 4 is a diagram illustrating a browser 400 according to another example implementation. The browser 400 may include tabs for tabbed documents similar to tabbed browser 200, or may be a tabless browser, similar to browser 300, as examples. These are just examples. Browser 400 may include one or more additional features as described below. Browser 400 may include a window 408 which includes a content area 410. A task switcher/launcher interface 412 may, for example, include a ranked task bar 413, a more button 415 and a search bar 414.

According to an example implementation, the ranked task bar 413 may include an icon (e.g., tile or other selectable GUI object) for each of a plurality of ranked tasks from the ranked list of tasks 122 generated by the task recommendation engine 120. For example, an icon or other selectable GUI object, such as icons 422, 424, 426 or 428, may be provided for each of the top Z (e.g., top 5) ranked tasks from the ranked list of tasks 122 for a user. Each icon (e.g., 422, 424, 426, 428 . . . ) may represent a selectable task. Each selectable icon (e.g., tile) within ranked task bar 413 may include a site title 416 that identifies a title (or other descriptive information) of the site for the task. For example, icon 422 is entitled Document 1, icon 424 is entitled Document 2, icon 426 is entitled Music App, and icon 428 is entitled Chess site.

Each selectable icon (or tile) within ranked task bar 413 may also include a visual depiction of the site. For example, selectable icon 422 for Document 1 includes a visual depiction 418. The other selectable icons or tiles 424, 426 and 428 may also include a visual depiction of the associated site. For example, a crown is used as a visual depiction of the Chess site for icon 428.

Optionally, one or more icons or tiles (422, 424, 426, 428 . . . ) within ranked task bar 413 may include a sub-icon that identifies a mode of navigation for the associated task. For example, a first sub-icon may indicate a launch mode, and a second sub-icon may indicate a switch mode of navigation. For example, the icon 420, e.g., an arrow, (for icon 424) may indicate a switch mode of navigation for the task associated with icon 424.

The more button 415 may allow a user to display icons for additional tasks or more tasks than are displayed initially in the ranked task bar 413. Thus, a user may request and obtain display of an extended list of the ranked list of tasks 122, e.g., displayed as an extended ranked task bar (not shown) that may display icons for the top 12 (as an example) ranked tasks.

Also, the search bar 414 may be used by a user to perform a search based on one or more terms, URLs, etc. In an example implementation, the search results from a search input to search bar 414 may incorporate, and display as search results, one or more tasks (or sites for ranked tasks). For example, a search term matching a term in a title for a ranked task within a ranked list of tasks 122 may be displayed within the search results, along with one or more general Internet search results. Thus, the search results from a search input via search bar 414 may be supplemented (or may include) one or more tasks in the ranked list of tasks 122 for the user, e.g., which match or correlate to one or more search terms.

As noted, the ranked task bar 413 within the task switcher/launcher interface 412 may include an icon (e.g., a tile or other selectable GUI object) for each of a plurality of the tasks of the ranked list of tasks 122 generated by the task recommendation engine 120. In operation, a user pressing or selecting the task switcher/launcher request button 312 on browser 400 may cause browser 400 to retrieve a ranked task list 122 for the user (e.g., either from local memory at client computer 110 or from a server or cloud service), and then to display a portion of the ranked list of tasks 122 within the ranked task bar 413.

Once the task switcher/launcher interface 412 has been displayed, including ranked task bar 413, a user may select one of the displayed tasks, e.g., select one of the icons (422, 424, 426, or 428) associated with a task within ranked task bar 413. In response to a signal selecting a displayed task, the browser 400 may determine a site and a mode of navigation for the selected task, e.g., based on the ranked list of tasks 122 that was received by browser 400 from task recommendation engine 120. For example, if a user selects icon 428, browser 400, or other program, may determine the site for this selected task (e.g., identify the URL or address for this Chess site), and a mode of navigation as a launch mode for this selected task.

Next, browser 400 may perform site navigation for the selected task based upon the mode of navigation for the selected task. For example, performing site navigation may include launching a new page from the site based on the site (e.g., URL) for the selected task if the mode of navigation is launch mode. Also, for example, for switch mode tasks, a task provided in the ranked task list 122 may have a link or reference to a corresponding stored context (e.g., stored in stored contexts 116A or 116B) for the task. Thus, for example, performing site navigation may include switching to a stored context for the site for the task if the mode of navigation for the selected task is switch mode. Switching to a stored context may include, for example, retrieving the stored context for a selected task, and then displaying the site with the stored context, e.g., to restore the site for the selected task to the state seen by the user when the user last visited this site.

Thus, according to an example implementation, selection of a single button, e.g., one of the displayed tasks within ranked task bar 413 may allow a user to navigate to a task, either launch mode or switch mode, where the mode of navigation for the task is automatically (i.e., without human input) selected by the browser based upon the ranked list of tasks 122 determined or generated by the task recommendation engine 120. Thus, according to an example implementation, a manual management of tabs or tabbed documents may be supplemented or even replaced with an electronic or (at least partially) automatic technique in which the browser 400, based on information in the ranked list of tasks 122, may determine which tasks to suggest or propose in ranked task bar 413, including whether to launch a new page for the site or switch to a saved context.

According to an example implementation, the ranked task bar 413 in browser 400, which may display a portion (e.g., the most highly ranked tasks or tasks having a greatest likelihood of being selected by a user) of the ranked list of tasks 122, may be similar to a tabbed browsers tab strip 214. Therefore, the ranked task bar 413 is different from the tabbed browser in that manual management (e.g., manually moving tabs/tabbed documents around, selecting and closing various tabs or tabbed documents) may be replaced (at least in some cases) with the task ranking performed by the task recommendation engine 120 to generate the ranked task list 122, the results of which may then be displayed to the user (at least in part) via the ranked task bar 413.

Furthermore, browser 400 and/or task recommendation engine 120, may also determine which stored contexts (saved in stored contexts 116A or 116B) should be maintained/kept, and which contexts should be deleted or evicted from storage. For example, when a threshold percentage of memory, e.g., 90 percent of memory (either system memory or memory allocated for stored contexts 116) has been reached based on stored contexts, then contexts associated with one or more of the lowest ranked switch mode tasks may be deleted or evicted from the stored contexts 116, e.g., to free up memory to store other contexts for tasks that may be more highly ranked.

Deletion/eviction of stored contexts may be especially important where contexts are store locally on client computer 112 (e.g., as stored contexts 116A). All or part of the stored contexts may be stored on a server or cloud service within stored contexts 116B, and may be retrieved by browser 400 on client computer 110 as needed, e.g., upon selection of a switch mode task within ranked task bar 413. Also, for example, contexts associated with tasks that are deleted from the ranked list of tasks 122 may be deleted or evicted from the stored contexts 116.

In another example implementation, a two-level context storage may be used in which the contexts of a first set of most highly ranked switch mode tasks are stored locally within stored contexts 116A (to decrease access latency for most highly ranked tasks), while a second set of contexts for lower ranked tasks may be stored at a server or cloud service within contexts 116B, e.g., to provide increased storage of contexts for a larger or extended set of lower/lowest ranked tasks, for example.

A task switcher/launcher request signal may be generated (and input to browser 400) in response to selection of the task switcher/launcher request button 312, or other input. Furthermore, different task switcher/launcher request signals may be generated (e.g., based on different input signals or gestures) by a user to filter the ranked list of tasks 122 to display a different or varying set of tasks within the ranked task bar 413. For example, a first gesture (e.g., left swipe on browser content area) by a user may cause the browser 400 to display a ranked task bar 413 (within the task switcher/launcher interface 412) that includes a selectable icon for a plurality of tasks having launch mode as a mode of navigation (e.g., first gesture to display only launch mode tasks). While a second gesture (e.g., right swipe or double tap on browser content area) by a user may cause browser 400 to display a ranked task bar that includes a selectable icon for a plurality of tasks having switch mode as the mode of navigation (e.g., a second gesture to display only switch mode tasks). Thus, for example, different task switcher/launcher request signals (e.g., different signals or gestures input to browser 400) may be used to display a different subset of the tasks of the ranked list of tasks 122 for display onto ranked task bar 413.

In an illustrative example, the top X (e.g., 5) most highly ranked launch mode tasks may be displayed within ranked task bar 413 in response to a first gesture received by browser 400 from a user, while the top Y (e.g., 5) most highly ranked switch mode tasks may be displayed within the ranked task bar 413 in response to a second gesture or a second input signal received by browser 400 from a user. Also, in an example implementation, pressing or selecting the more button 415 may result in more tasks (or associated icons) of the requested type (e.g., launch mode tasks or switch mode tasks) being displayed in an extended ranked task bar, for example. Also, after entering a first gesture (e.g., to request launch mode tasks) or a second gesture (e.g., to request switch mode tasks), a search phrase or URL may be input the search bar 414, and the search results may include one or more tasks of the specific requested type (launch mode or switch mode), or the search results may be weighted in favor of displaying (in the search bar 414) tasks or search results of the requested type, or alternatively, or search results that include only search results or tasks of the requested type, according to various example implementations.

Also, the task recommendation engine 120 may learn from (or adapt based upon) mistakes or errors, and correct (or attempt to correct) launch/switch decisions for tasks, or task ranking decisions in general, e.g., by updating a ranking of one or more tasks within the ranked list of tasks 122 for the user. Also, browser 400 may perform additional actions (e.g., such as performing navigation for other tasks, or re-displaying the ranked task bar 413 with tasks that have been adjusted based on this user feedback) in response to receiving information that the requested or displayed task/site was not what the user wanted to select/display. Further details are described below.

For example, sometimes the task recommendation engine 120, based on the ranked list of tasks 122, may have proposed (via tasks displayed on the ranked task bar 413) to launch a site for a task, when the user may have actually wanted to switch to a context for the site (e.g., user actually wanted to select/display a different task, with the same site, having a different mode of navigation). Or, similarly, a task recommendation engine 120 may have proposed (e.g., via a task displayed on the ranked task bar 413) to switch to a context for a site for a task when the user really wanted to launch the site. After a browser 400 performs site navigation for the selected/requested task (e.g., launch a site or switch to a context for the site associated with the task), the user may provide a signal or an input to browser 400 that indicates that the user has generally rejected the selected task, or otherwise indicates that the user wanted to display (or perform site navigation for) a different task.

In response to receiving this signal indicating that the user has rejected the selected and displayed task, the browser 400 may: 1) perform site navigation for an alternative task (e.g., navigate to the same site as the rejected task, but with a different mode of navigation) or re-display the ranked task bar 413 with the previously selected task (which was in error or not what the user wanted to display) removed from the ranked task to allow the user to select a different task; and/or 2) notify the task recommendation engine 120 of the user rejection to the selected task (e.g., as user feedback, or user activity metadata), and in such case, task recommendation engine 120 may update the ranked list of tasks 122 to decrease the rank of the rejected task, for example. This is an example of task recommendation engine 120 updating the ranked list of tasks 120 based on user activity meta data.

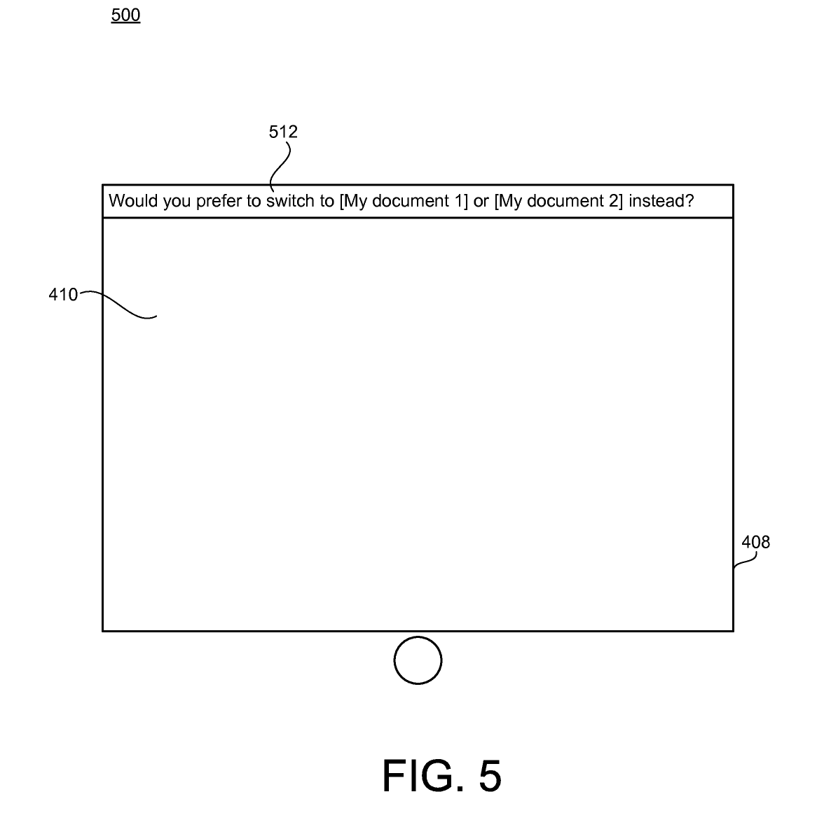

Many different techniques may be used by the user to reject a selected task. Two example techniques for rejecting a selected task include: 1) after the browser has navigated to the site for the selected task, determining (by browser 400 or task recommendation engine 120) that the browser 400 remained at the navigated site for the selected task for an amount of time that is less than a threshold (e.g., less than 5 seconds), before the user provided input to redirect or re-navigate the browser 400 away from such site, e.g., redirected to a different site or menu; and 2) a user explicitly providing a rejection indication for the selected task. Some examples of a user providing an explicit rejection signal may include the user of a task correction interface 512 (FIG. 5) and the use of a task mode signal, also described below. According to one illustrative example, a vertical swipe across a task (or across a tile for a task) may be used to reject the task. A tap on the tile may be used to select the tile/task, for example. These are merely some examples, and other signals or techniques may be used.

FIG. 5 is a diagram illustrating a browser 500 according to another example implementation. Browser 500 may be the same as or similar to browser 400, which some additional or different features described below. For example, with respect to technique 2), once the task switcher/launcher interface 412 has been displayed, including ranked task bar 413, a user may select one of the displayed tasks, such as a news website for launch mode. In response to a signal selecting a displayed task, the browser 400 may perform navigation to the selected task, e.g., may launch the site (news website in this example) for the task. When the site for the selected task is displayed by browser 500, browser 500 may also display a task correction interface 512. Task correction interface 512 may include one or more selectable GUI objects that may be selected to either reject the currently displayed task or site, or otherwise request a different site or task. In one example implementation, task correction interface 512 may, for example, be temporarily displayed (such as a pop-up interface), e.g., displayed only during the first 5 seconds after the site of the selected task is displayed.

Some examples of selectable objects within task correction interface 512 may include objects that state: “Back to ranked task toolbar.” Or, as shown in FIG. 5, the task correction interface 512 may state: “Would you prefer to switch to: [My Document 1] or [My Document 2]” to allow a user to switch to one of the listed documents/sites, for example. In some example implementations, the task correction interface 512 may be displayed if a confidence level associated with a selected task is low (e.g., task recommendation engine 120 may assign a confidence level to each ranked task within the ranked list of tasks 122). For example, one or more alternative sites or tasks may be displayed in task correction interface 512 to allow the user to select one or more other tasks (or sites for such tasks). For example, if a switch mode task was selected (e.g., causing browser to retrieve and display a context for the site), browser 500 may include in the task correction interface 512 one or more (e.g., of the highest ranked) launch tasks. Or if a selected launch mode task was selected (causing the browser 500 to launch the site for the selected task), browser 500 may include in the task correction interface 512 one or more of the (e.g., highest ranked) switch mode tasks, which may include one or more switch mode tasks having a same site as the selected launch mode task, for example.

Alternatively, a user may select or input to the browser 400 or 500 a task mode change signal that indicates that the user would like to select the same site as the selected task, but for a different mode. The task mode change signal may be considered to be a specific type of task rejection signal, where the task mode change signal rejects only the mode of navigation for the selected task, but confirms the site of the selected task. For example, task 1, having a switch context for a site, may be selected by a user and displayed (switched context is retrieved and displayed). This site may not have been what the user wanted, and the user may input the task mode change signal (which may be a specific input or gesture) to browser 400/500. In response to browser 400/500 receiving a task mode change signal, browser 400/500 may launch the same site (e.g., with a different mode of navigation than the originally selected task) to effect the requested change of navigation mode. Similarly, browser 400/500 may initially launch a site based on a selection of a task, and the user may input the task mode change signal. The task mode change signal may therefore cause the browser 400/500 to switch to the most highly ranked context (or task) for the same site, to effect the requested change in navigation mode for the same site. This is merely one illustrative example, and others may be provided. According to an illustrative example, double tapping on a touch screen interface may be used to switch modes (i.e., to select the tile but in a different mode than the mode that is displayed), where a single tap on the touch screen may be used to select the tile in the proposed mode. This is merely one example and other gestures or inputs may be used.

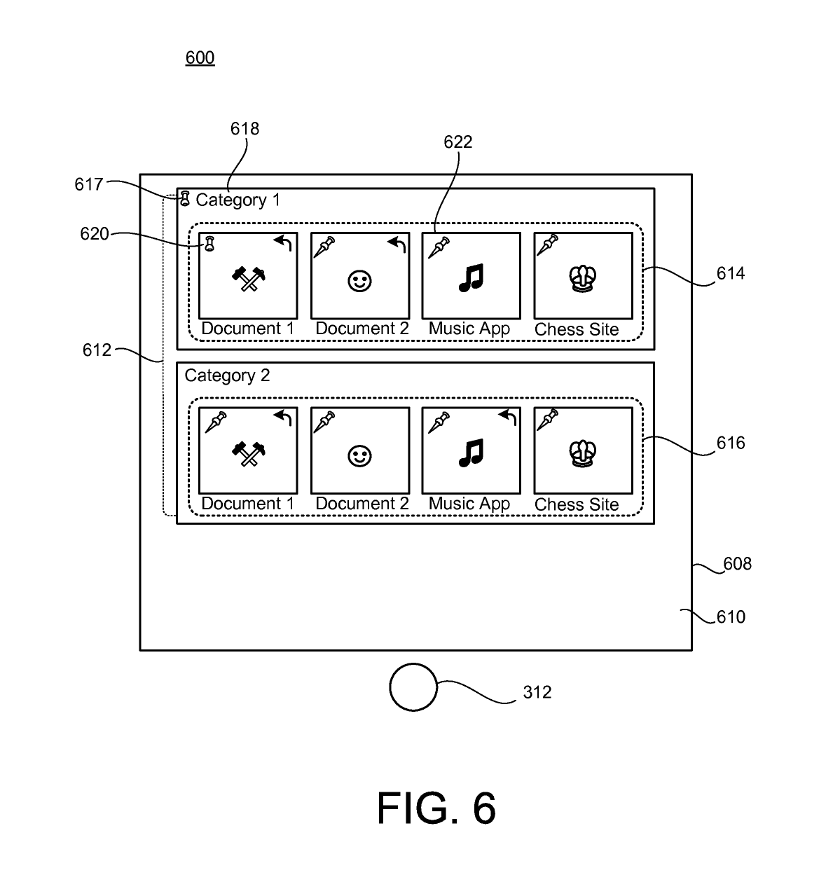

FIG. 6 is a diagram illustrating additional tasks that may be displayed for browser 500 when a more button is pressed according to an example implementation. When a user selects the more button 415 (FIG. 4), icons for one or more additional tasks (beyond what is displayed on ranked task bar 413) may be displayed within a browser 600. Browser 600 may include a window 608 and a content area 610 that may include or may display a more page that include one or more additional tasks. According to one example implementation, one or more uncategorized tasks (or icons for tasks) may be displayed in browser 600 in response to a selection of the more button 415.

According to another example implementation, as shown in FIG. 6, category task bars 612 may be displayed in response to a selection of the more button 415. According to an example implementation, category task bars 612 may include one or more ranked task bars for one or more categories, such as a ranked task bar 614 for category 1 and a ranked task bar 616 for category 2. Each ranked task bar 614, 616, etc., may include a title, such as title 618 (Category 1). Each ranked task bar 614, 616, etc. may also include an icon (or tile) for each of a plurality of ranked tasks within a specific category of tasks, where the tasks (or icon for each of the tasks) may, for example, be displayed in decreasing rank, e.g., left to right., within each ranked task bar.

Each category (or ranked task bar for a category) may include or display a list of tasks that match a specific semantic criteria, of a certain type of task, or which may be logically grouped together. For example, a ranked task bar for a category may provide or display a list of tasks which include: URLs of recently closed tabs or pages; URLs open in a web browser running on another device(s); URLs of documents that are frequently accessed; URLs of the user's favorite sports web sites; URLs of the user's favorite web comic web sites; URLs that the user has manually bookmarked; URLs of the user's favorite news web sites, URLs of a specific type (e.g., sports or news) that were manually bookmarked by the user, etc. A miscellaneous category of tasks may be provided for tasks that do not fit any other category. In another example implementation, a ranked task bar of a category may also be limited to only launch tasks of a particular category, or only switch tasks of a particular category, e.g., launch tasks for news sites.

In an example implementation, various categories may be ranked by task recommendation engine 120 using the same or similar criteria that task recommendation engine 120 uses to rank tasks. Thus, in an illustrative example implementation, only ranked task bars for categories that are ranked in the top N (e.g., top 5) categories are displayed within the browser 600 (unless such categories/task bars have been pinned). For example, task recommendation engine 120 may generate a ranked category list for each of a plurality of users. The categories may, for example, be ranked based on a likelihood that a task or tasks within such category will be selected by a user, e.g., where a higher ranked category has been determined by the task recommendation engine 120 to have one or more tasks within such category that have a greater likelihood of being selected by the user. For example, similar to the ranking of tasks, the task recommendation engine 120 may determine a ranked list of categories based upon signals relating to one or more of the following: user activity metadata (including launch/switch history for user) for a plurality of sites, whether a context for a site is stored or available, general use metadata of multiple users for a plurality of sites, and intrinsic metadata.

According to an example implementation, a user may pin a ranked task bar for a specific category to be displayed in browser 600 when the more button 415 has been selected. Also, one or more specific tasks may be pinned within a ranked task bar for a category (e.g., to ensure that such task always appears within such ranked task bar). Each category may include an icon, e.g., icon 617 for category 1, indicating that a category or a ranked task bar for a category is pinned to browser 600. An icon, such as icon 622, may be provided to indicate that a task can be pinned within a ranked task bar for a category. Also, an icon, such as icon 620, may be provided to indicate that a task has been pinned within a ranked task bar for a category. By pinning a category or ranked task bar for a category or a task, a user may manually cause such pinned ranked task bar for such category to be displayed in browser 600, or manually cause such pinned task to be displayed within a displayed ranked task bar for a category, e.g., when a user selects the more button 415, regardless of a ranking performed by task recommendation engine 120. Thus, for example, a user's favorite category (or ranked task bar for the user's favorite category), such as sports web sites, may be pinned to the top of browser 600 so that this pinned category always appears on browser 600 when the more button 415 is pressed, regardless of a ranking of such categories (or ranked task bar for categories) performed by the task recommendation engine 120. Thus, pinning of a ranked task bar (e.g., 614, 616) for a category or pinning of a task will bypass or over-ride the ranking (or ranking algorithm) performed by the task recommendation engine 120 to rank categories and tasks.

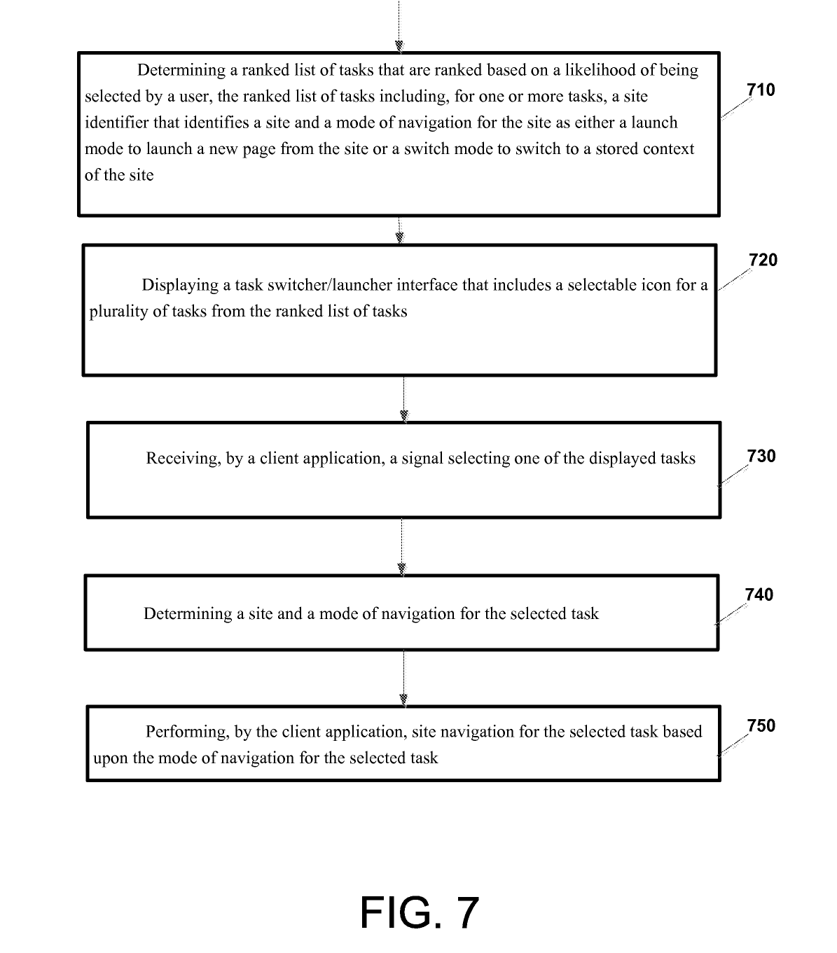

FIG. 7 is a flow chart illustrating operation of a client application according to an example implementation. Operation 710 includes determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site. Operation 720 includes displaying a task switcher/launcher interface that includes a selectable icon for a plurality of tasks from the ranked list of tasks. Operation 730 includes receiving, by a client application, a signal selecting one of the displayed tasks. Operation 740 includes determining a site and a mode of navigation for the selected task. Operation 750 includes performing, by the client application, site navigation for the selected task based upon the mode of navigation for the selected task.

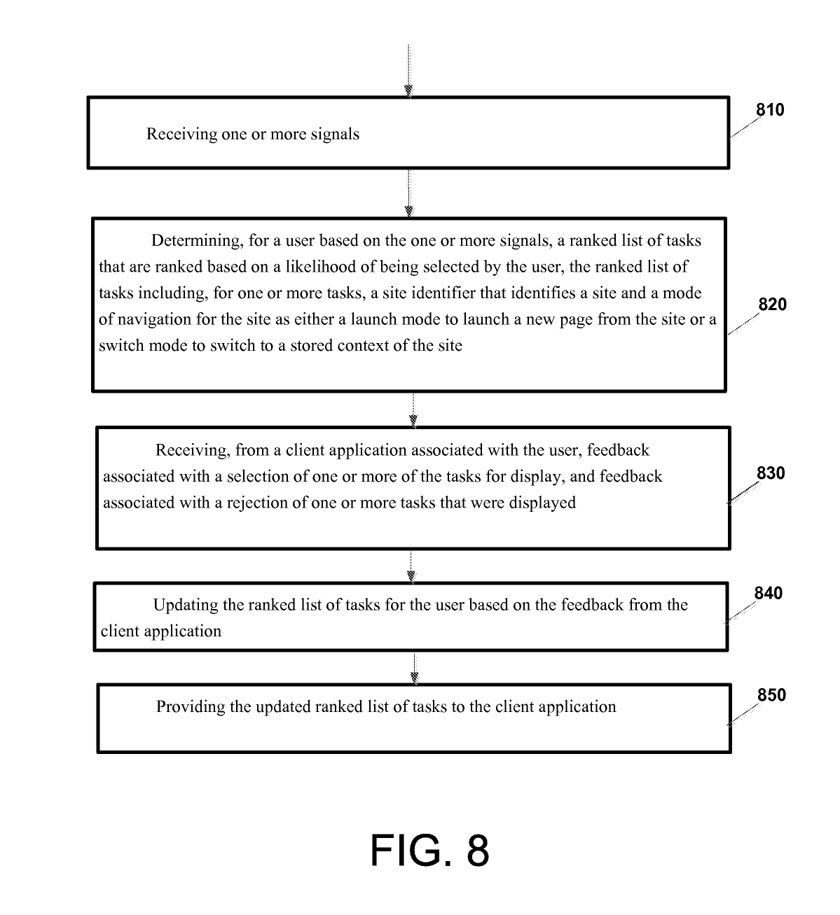

FIG. 8 is a flow chart illustrating operation of a task recommendation engine according to an example implementation. Operation 810 includes receiving one or more signals. Operation 820 includes determining, for a user based on the one or more signals, a ranked list of tasks that are ranked based on a likelihood of being selected by the user, the ranked list of tasks including, for one or more tasks, a site identifier that identifies a site and a mode of navigation for the site as either a launch mode to launch a new page from the site or a switch mode to switch to a stored context of the site. Operation 830 includes receiving, from a client application associated with the user, feedback associated with a selection of one or more of the tasks for display, and feedback associated with a rejection of one or more tasks that were displayed. Operation 840 includes updating the ranked list of tasks for the user based on the feedback from the client application. Operation 850 includes providing the updated ranked list of tasks to the client application.

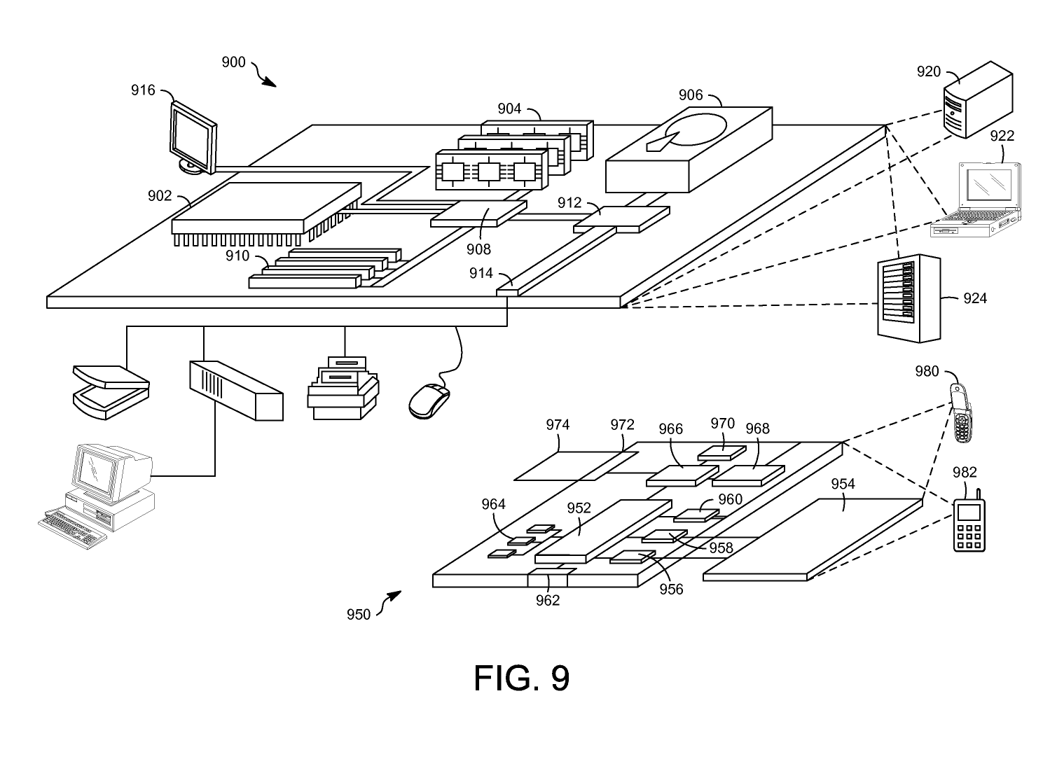

FIG. 9 shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method comprising:
determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site;
determining, by a client application, a task mode change gesture that may be used to switch a mode of a selected task, wherein the task mode change gesture, when detected by the client application, rejects a mode of navigation of the selected task and confirms a site of the selected task;
displaying a task switcher/launcher interface that includes a selectable icon for a plurality of tasks from the ranked list of tasks;
receiving, by a client application, a signal selecting a first task of the displayed tasks;
determining a site and a first mode of navigation for the selected first task;
detecting, by the client application, the task mode change gesture;
determining a second mode of navigation, different from the first mode of navigation, in response to the detecting the task mode change gesture; and
performing, by the client application, site navigation for the selected first task based upon the site of the selected first task and the second mode of navigation.

2. The method of claim 1 wherein performing site navigation for the selected first task comprises:
launching a new page of the site for the selected first task if the second mode of navigation is launch mode; and
switching to a stored context of the site for the selected first task if the second mode of navigation is switch mode.

3. The method of claim 1 wherein the determining a ranked list comprises receiving the ranked list from a task recommendation engine running on a server.

4. (canceled)

5. The method of claim 31 wherein the displayed icon for each task of the subset of tasks includes a displayed sub-icon that identifies the mode of navigation for the task.

6. The method of claim 28 and further comprising:
receiving a task switcher/launcher request signal;
determining whether the task switcher/launcher request signal is a first gesture or a second gesture; and
wherein the displaying a task switcher/launcher interface includes:
displaying, if the task switcher/launcher request signal is the first gesture, a task switcher/launcher interface that includes a selectable icon for a plurality of tasks from the ranked list of tasks that each have launch mode as a mode of navigation; and
displaying, if the task switcher/launcher request signal is the second gesture, a task switcher/launcher interface that includes a selectable icon for a plurality of tasks from the ranked list of tasks that each have switch mode as a mode of navigation.

7. The method of claim 1 wherein determining a ranked list of tasks is performed based upon one or more of the following:
user activity metadata for a plurality of sites;
whether a context for a site is stored or available; and
general use metadata of multiple users for a plurality of sites.

8. The method of claim 7 wherein the user activity metadata comprises one or more of the following:
frequency of visits to a site;
time and duration of visits to a site;
amount of user interaction at a site;
relative frequency of launching vs. switching to a site; and
feedback from a user indicating that a navigated site has been rejected by the user.

9. (canceled)

10. The method of claim 28 wherein performing site navigation for the selected task comprises performing, by the client application, site navigation for the selected task for a first mode of navigation, the method further comprising:
determining that the client application remained at the navigated site for the first mode of navigation for an amount of time that is less than a threshold; and
performing site navigation to the site of the selected task for a second mode of navigation that is different than the first mode of navigation.

11. The method of claim 28 wherein performing site navigation for the selected task comprises launching a new page of the site for the selected task, and the method further comprising:
determining that the client application remained at the launched page for an amount of time that is less than a threshold; and
switching to a stored context of the site for the selected task.

12. The method of claim 28 wherein the performing site navigation for the selected icon comprises switching to a stored context of the corresponding site for the selected icon, the method further comprising:
determining that the client application remained at the stored context of the corresponding site for the selected icon for an amount of time that is less than a threshold; and
launching a new page of the corresponding site for the selected icon.

13. The method of claim 1 wherein the ranked task list comprises:
the first task with a first site identifier that identifies a first site and a mode of navigation of launch mode; and
one or more second tasks with the first site identifier that identifies the first site and a mode of navigation of switch mode to switch to a stored context for the site.

14. The method of claim 1 and further comprising:
storing one or more contexts for one or more sites based on user interaction with the site; and
deleting, as stored contexts reach a threshold number or reach a threshold amount of memory, one or more stored contexts for lowest ranked tasks within the ranked list of tasks.

15. The method of claim 1 and further comprising displaying, in response to a user input, a ranked task bar for each of one or more categories of tasks, each ranked task bar including an icon for a plurality of tasks within a category of tasks.

16. A computer program product, the computer program product comprising a non-transitory computer-readable storage medium and storing executable code that, when executed by at least one data processing apparatus, is configured to cause the at least one data processing apparatus to perform a method comprising:
determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site;
determining, by a client application, a task mode change gesture that may be used to switch a mode of a selected task, wherein the task mode change gesture, when detected by the client application, rejects a mode of navigation of the selected task and confirms a site of the selected task;
displaying a task switcher/launcher interface that includes a selectable icon for a plurality of tasks from the ranked list of tasks;
receiving, by a client application, a signal selecting a first task of the displayed tasks;
determining a site and a first mode of navigation for the selected first task;
detecting, by the client application, the task mode change gesture;
determining a second mode of navigation, different from the first mode of navigation, in response to the detecting the task mode change gesture; and
performing, by the client application, site navigation for the selected first task based upon the site of the selected first task and the second mode of navigation.

17. The computer program product of claim 16 wherein the performing site navigation for the selected first task comprises:
launching a new page of the site for the selected first task if the second mode of navigation is launch mode; and
switching to a stored context of the site for the selected first task if the second mode of navigation is switch mode.

18-24. (canceled)

25. The method of claim 28 wherein the list of tasks comprises a ranked list of tasks that are ranked based upon one or more of the following:
user activity metadata for a plurality of sites;
whether a context for a site is stored or available; and
general use metadata of multiple users for a plurality of sites.

26. The method of claim 25 wherein the user activity metadata comprises one or more of the following:
frequency of visits to a site;
time and duration of visits to a site;
amount of user interaction at a site;
relative frequency of launching vs. switching to a site; and
feedback from a user indicating that a navigated site has been rejected by the user.

27. (canceled)

28. A method comprising:
determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site;
displaying a task switcher/launcher interface that includes a plurality of selectable icons, each selectable icon indicating at least a corresponding site, wherein the corresponding site may have a mode of navigation as either launch mode or switch mode;
receiving, by a client application, a signal selecting one of the selectable icons and the corresponding site;
selecting, automatically by the client application based on the ranked list of tasks without requiring receiving further selection input, a mode of navigation for the selected icon and corresponding site; and
performing, by the client application, site navigation for the selected icon and corresponding site based upon the automatically selected mode of navigation for the selected icon and corresponding site.

29. The method of claim 28 wherein the determining a ranked list comprises receiving the ranked list from a task recommendation engine running on a server.

30. The method of claim 28 and further comprising:
storing one or more contexts for one or more sites based on user interaction with the one or more sites; and
deleting, as stored contexts reach a threshold number or reach a threshold amount of memory, one or more stored contexts for lowest ranked tasks within the ranked list of tasks.

31. A method comprising:
determining a ranked list of tasks that are ranked based on a likelihood of being selected by a user, the ranked list of tasks including, for one or more tasks, a site identifier that identifies a site and a mode of navigation for the site as either a launch mode to launch a new page from the site or a switch mode to switch to a stored context of the site;
receiving a navigation mode selection signal for a selected mode of navigation; and
displaying a task switcher/launcher interface that includes a selectable icon for each task of a subset of tasks that have the selected mode of navigation from the ranked list of tasks.

32. The method of claim 31:
wherein the receiving comprises receiving either a first navigation mode selection signal to select a launch mode of navigation or a second navigation mode selection signal to select a switch mode of navigation; and
wherein the displaying comprises performing one of the following:
displaying a task switcher/launcher interface that includes a selectable icon for each task of a subset of tasks that have the launch mode of navigation from the ranked list of tasks, if the first navigation mode selection signal is received; and
displaying a task switcher/launcher interface that includes a selectable icon for each task of a subset of tasks that have the switch mode of navigation from the ranked list of tasks, if the second navigation mode selection signal is received.

33. The method of claim 31 and further comprising:
receiving a search phrase; and
adjusting, based on the search phrase, the displayed selectable icons for the subset of tasks.

34. The method of claim 31 and further comprising:
receiving, by a client application, a signal selecting one of the displayed tasks;
determining a site and a mode of navigation for the selected task; and
performing, by the client application, site navigation for the selected task based upon the mode of navigation for the selected task.
